(19) United States
(12) Patent Application Publication
(10) Pub. No.: US 2026/0368468 A1
(43) Pub. Date: Nov. 19, 2026

(54) CHARGE AND FIRE RADIO-FREQUENCY IDENTIFICATION (RFID) TAG

(71) Applicant: Powercast Corporation, Pittsburgh, PA (US)

(72) Inventors: Jason Arthur GILL, Pittsburgh, PA (US); Eric James BIEL, Glenshaw, PA (US); Richard T. BROPHY, Pittsburgh, PA (US)

(21) Appl. No.: 19/681,795

(22) Filed: May 19, 2026

Related U.S. Application Data
(60) Provisional application No. 63/808,535, filed on May 19, 2025.

(51) Int. Cl. G06K 19/07; H02J 50/20

(52) U.S. Cl. CPC G06K 19/0701; H02J 50/20

(57) ABSTRACT

An apparatus includes an antenna configured to receive radio-frequency (RF) energy. At least one of a signal splitter or a signal switch is coupled to the antenna. An RF-to-DC converter is coupled to the at least one of the signal splitter or the signal switch and configured to convert RF energy received from the at least one of the signal splitter or the signal switch into DC energy. An energy storage device is coupled to the RF-to-DC converter. Monitoring circuitry is coupled to the energy storage device, coupled to the RF-to-DC converter, and configured to determine when an amount of energy stored in the energy storage device is sufficient to power a radio-frequency identification (RFID) to complete an RFID transaction. A power management integrated circuit (PMIC) is coupled to the monitoring circuitry and configured to be couplable to the RFID.

### CROSS REFERENCE TO RELATED APPLICATION

This application claims priority to U.S. Provisional Patent Application No. 63/808,535, filed May 19, 2025 and titled “CHARGE AND FIRE RADIO-FREQUENCY IDENTIFICATION (RFID) TAG,” the contents of which are incorporated by reference herein in its entirety.

### FIELD

One or more embodiments relate to a charge-and-fire radio frequency identification (RFID) tag.

### BACKGROUND

Radio-frequency identification (RFID) tags can have a minimum threshold of radio-frequency (RF) power to operate. When an RFID tag is located at a sufficient distance from an RFID reader, or when conditions such as polarization mismatch or poor reflection coefficients reduce the available RF energy, the amount of RF energy received by the tag can fall below this threshold, rendering the tag unable to power itself, decode incoming data, and/or backscatter data back to the reader. Even in situations where the tag can be powered, the energy available for backscatter communication can be insufficient for the reader to decode the tag's response, thereby limiting the effective communication range of the system. As such, it would be desirable to provide RFID tag architectures that can extend the operational range of the tag by enabling operation at RF power levels below the tag's native sensitivity threshold.

### SUMMARY

In an embodiment, an apparatus includes an antenna configured to receive radio-frequency (RF) energy. The apparatus further includes at least one of a signal splitter or a signal switch coupled to the antenna and configured to route at least a portion of the RF energy. The apparatus further includes an RF-to-DC converter coupled to the at least one of the signal splitter or the signal switch and configured to convert RF energy received from the at least one of the signal splitter or the signal switch into DC energy. The apparatus further includes an energy storage device coupled to the RF-to-DC converter and configured to store the DC energy. The apparatus further includes monitoring circuitry that is coupled to the energy storage device, coupled to the RF-to-DC converter, and configured to determine when an amount of energy stored in the energy storage device is sufficient to power a radio-frequency identification (RFID) to complete an RFID transaction. The RFID can also be coupled to the at least one of the signal splitter or the signal switch. The apparatus further includes a power management integrated circuit (PMIC) coupled to the monitoring circuitry and configured to be couplable to the RFID. The PMIC is configured to cause delivery of power from the energy storage device to the RFID upon the monitoring circuitry determining that sufficient energy is stored at the energy storage device.

### BRIEF DESCRIPTION OF THE DRAWINGS

FIG. 1 illustrates a first circuit, according to an embodiment.

FIG. 2 illustrates a second circuit, according to an embodiment.

FIG. 3 illustrates a third circuit, according to an embodiment.

FIG. 4 illustrates a fourth circuit, according to an embodiment.

FIG. 5 illustrates a fifth circuit, according to an embodiment.

FIG. 6 illustrates a sixth circuit, according to an embodiment.

FIG. 7 illustrates a seventh circuit, according to an embodiment.

FIG. 8 illustrates an eighth circuit, according to an embodiment.

FIG. 9 illustrates a ninth circuit, according to an embodiment.

FIG. 10 illustrates a tenth circuit, according to an embodiment.

### DETAILED DESCRIPTION

Some implementations relate to circuits and apparatuses for extending the operational range of radio-frequency identification (RFID) tags (also referred to herein as “tags” or individually as a “tag”). In some known RFID systems, an RFID tag receives RF energy from an RFID reader (also referred to herein as a “reader”) and uses that energy to power itself and to backscatter data back to the reader. The amount of RF energy available to the tag, however, decreases with distance from the reader. At sufficiently large distances, or when conditions such as polarization mismatch or poor reflection coefficients reduce the available RF energy, the RFID tag may not receive enough power to operate. Even if the tag can be powered, the amount of energy available for backscatter communication can be insufficient for the reader to decode the tag's response.

Some techniques described herein address these limitations by storing RF energy over time and intermittently powering the RFID (e.g., RFID chip, RFID tag, and/or the like) (or components thereof) when sufficient energy has been accumulated. Rather than demanding continuous RF power at or above the tag's sensitivity threshold, circuits can convert incoming RF energy to DC (by an RF-to-DC converter), store the DC energy in an energy storage device, and, after monitoring circuitry determines that enough energy has been stored, deliver the stored energy to the RFID tag via a power management integrated circuit (PMIC). The PMIC can increase the voltage of the energy storage device to a voltage usable by the RFID tag. In this manner, the RFID tag is supplied intermittently with higher power rather than continuously with insufficient power, thereby extending the distance at which the tag can be powered. In some implementations, if the sensitivity of the RF-to-DC converter is better than that of the RFID, the RF-to-DC converter can be used to power the RFID directly, or to place the RFID in a battery-assisted passive mode, with or without the energy storage device, the monitoring circuitry, and/or the PMIC.

Some of the disclosed circuits further include amplifiers, such as reflection amplifiers and/or low noise amplifiers, to increase the communication link budget in one or both directions (reader-to-tag and tag-to-reader). In some implementations, a reflection amplifier receives RF energy, amplifies the RF energy, and retransmits the amplified RF energy on the same port from which the RF energy was received. In some implementations, data modulation is achieved by controlling a DC power supply to the reflection amplifier: supplying DC power to the reflection amplifier causes the reflection amplifier to amplify and transmit RF energy, and removing DC power from the reflection amplifier causes the reflection amplifier to cease transmitting RF energy, thereby enabling amplitude-shift keying (ASK) modulation of the backscattered RF signal by selectively enabling and disabling the DC power supply to the reflection amplifier. Some circuits integrate RFID functionality (e.g., modulation, demodulation, memory, and digital logic) into the same chip as the energy harvesting and power management components, in the form of an application-specific integrated circuit (ASIC). Some circuits include intermediate power conversion stages, such as charge pumps, to increase the voltage of the stored energy to usable logic levels. Some circuits operate as intermittently powered repeaters or boosters that store RF energy and use the stored energy to power a reflection amplifier when enough energy is stored or upon receiving a trigger from an ultra high frequency (UHF) RFID reader.

The following terms are used throughout this disclosure and are described here by way of non-limiting example. In some implementations, the term “coupled” refers to a connection between two components that is made directly, without intervening devices such as other circuits or switches therebetween. In some implementations, the term “couplable” refers to an electrical connection between two components that can be made or broken, such as through a switch or other controllable element. In some implementations, the term “RF energy” refers to electromagnetic energy at radio frequencies, which may or may not carry information (in contrast to an “RF signal,” which can refer to RF energy that carries information, such as commands or data). In some implementations, an “RFID transaction” refers to one or more operations performed by an RFID in communication with an RFID reader, such as receiving a command, processing the command, accessing memory, and/or backscattering a response. In some implementations, an “energy storage device” includes, but is not limited to, one or more of a capacitor (e.g., an electrolytic capacitor, a ceramic capacitor, a tantalum capacitor, or a supercapacitor), a battery (e.g., a lithium-ion battery or a solid-state battery), or an inductor. In some implementations, “monitoring circuitry” includes, but is not limited to, one or more of a voltage supervisor, a comparator, a timer, an operational amplifier, or a microcontroller with hysteresis. In some implementations, a “PMIC” or “power management integrated circuit” includes, but is not limited to, one or more of a DC-to-DC converter (e.g., a boost converter or a buck converter), a low-dropout regulator (LDO), a charge pump, a switched-capacitor converter, a shunt regulator, or a voltage multiplier. In some implementations, the PMIC is configured to increase the voltage of the energy storage device to a voltage usable by the other circuitry, such as the RFID. In some implementations, a “signal splitter” or “signal switch” includes, but is not limited to, one or more of a coupler, a circulator, a power splitter, a power combiner, a power divider (e.g., a Wilkinson power divider, which can be implemented using discrete components), or an RF switch. In some implementations, a signal splitter and/or signal switch can include impedance matching networks and can be tuned together with other components to select a power split ratio and to match the impedance of an antenna.

In some implementations, an “RFID” includes, but is not limited to, one or more of an RFID chip, an RFID integrated circuit, an RFID digital core, an analog front end (AFE), or discrete RFID components.

In some implementations, a “memory” includes, but is not limited to, one or more of an electrically erasable programmable read-only memory (EEPROM), a flash memory, a non-volatile memory (NVM), a static random-access memory (SRAM), a register file, or a one-time programmable (OTP) memory.

Additional description related to RF-to-DC converter output impedance manipulation, power splitting techniques, and the use of an RF-to-DC converter as a modulator and/or demodulator can be found in U.S. Patent Application Publication No. 2024/0364314, filed Jul. 9, 2024, the contents of which are incorporated by reference herein in their entirety.

In the figures, dashed lines between components indicate control signals.

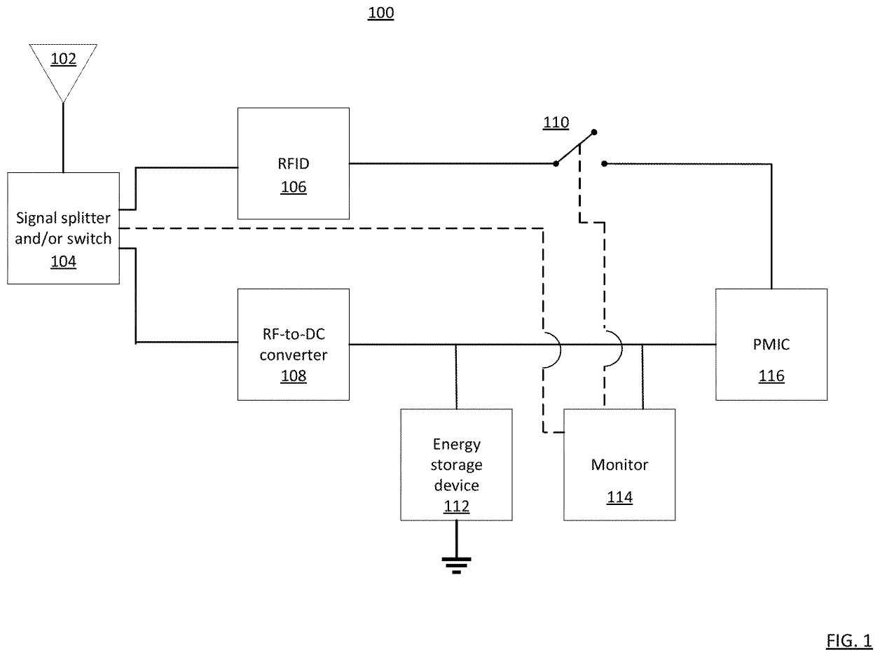

Although the circuits described herein are illustrated and described separately with respect to FIGS. 1-10, features of any one circuit can be combined with features of any other circuit unless such features are mutually inconsistent. For example, a component or connection described with respect to one figure can be added to or substituted into a circuit described with respect to another figure.

FIG. 1 illustrates a circuit 100, according to an embodiment. The circuit 100 includes an antenna 102 configured to receive electromagnetic energy and convert it to radio-frequency (RF) energy. The antenna 102 is coupled to a signal splitter and/or switch 104 via a wired connection (shown as a solid line in FIG. 1). The signal splitter and/or switch 104 is configured to route at least a portion of the RF energy received by the antenna 102. In some implementations, the signal splitter and/or switch 104 includes one or more of a coupler, a circulator, a power splitter, a power combiner, a power divider (e.g., a Wilkinson power divider, which may be implemented using discrete components), or an RF switch. The signal splitter and/or switch 104 can include an impedance matching network(s) and can be tuned together with other components to select a power split ratio and to match the impedance of the antenna 102. In some implementations, the signal splitter and/or switch 104 is an RF switch that is controlled by monitoring circuitry, as described elsewhere herein. The signal splitter and/or switch 104 can include one or more passive tuning components configured to control splitting the RF energy. The signal splitter and/or switch 104 is coupled to an RFID 106 via a wired connection and is coupled to an RF-to-DC converter 108 via a wired connection. The RFID 106 and the RF-to-DC converter 108 are coupled in parallel to the signal splitter and/or switch 104, such that the signal splitter and/or switch 104 can route a first portion of the RF energy to the RFID 106 and a second portion of the RF energy to the RF-to-DC converter 108. The RFID 106 can include an RFID digital core and/or an analog front end (AFE). In some implementations, the RFID 106 operates in a battery-assisted passive mode.

The RF-to-DC converter 108 is configured to convert the RF energy received from the signal splitter and/or switch 104 into DC energy. The RF-to-DC converter 108 is coupled to an energy storage device 112 via a wired connection. The energy storage device 112 is an energy storage component, such as a capacitor (e.g., an electrolytic capacitor, a ceramic capacitor, a tantalum capacitor, or a supercapacitor), a battery (e.g., a lithium-ion battery or a solid-state battery), and is configured to accumulate and store the DC energy output by the RF-to-DC converter 108 over time. The circuit 100 further includes monitoring circuitry, shown as monitor 114, coupled to the energy storage device 112 via a wired connection and coupled to the RF-to-DC converter 108 via a wired connection. The monitoring circuitry 114 is configured to determine when an amount of energy stored in the energy storage device 112 is sufficient to power the RFID 106 to complete an RFID transaction. For example, the monitoring circuitry 114 can include a voltage supervisor or comparator that compares a voltage across the energy storage device 112 to a predetermined threshold voltage corresponding to a minimum energy level required to power the RFID 106 for a duration sufficient to complete the RFID transaction. When the voltage across the energy storage device 112 meets or exceeds the predetermined threshold voltage, the monitoring circuitry 114 asserts an enable signal to the PMIC 116. In some implementations, the monitoring circuitry 114 includes hysteresis such that the enable signal is asserted when the voltage rises above an upper threshold and is de-asserted when the voltage falls below a lower threshold, thereby preventing rapid toggling of the PMIC 116 near the threshold voltage. In some implementations, the monitoring circuitry 114 includes a timer that, in conjunction with the voltage comparison, ensures that the energy storage device 112 has maintained the threshold voltage for a minimum period before asserting the enable signal. In some implementations, the monitoring circuitry 114 is configured to determine when to power the RFID 106, and the RFID 106 can signal the monitoring circuitry 114 to switch back when the RFID 106 has completed a current operation.

The circuit 100 further includes a power management integrated circuit (PMIC) 116 coupled to the energy storage device 112 via a wired connection. The PMIC 116 is configured to cause delivery of power from the energy storage device 112 to the RFID 106 upon the monitoring circuitry 114 determining that sufficient energy is stored at the energy storage device 112. The PMIC 116 can also increase the voltage of the energy storage device 112 to a voltage usable by the RFID tag 106. As shown in FIG. 1, the circuit 100 optionally includes a switch 110, coupled between the RFID 106 and the PMIC 116. When the switch 110 is present, the PMIC 116 is couplable to the RFID 106 via the switch 110, such that the switch 110 can selectively connect or disconnect the PMIC 116 from the RFID 106. In some implementations in which the switch 110 is present, the RFID 106 is not directly connected to the PMIC 116 without the switch 110 therebetween. In some implementations, the switch 110 is controlled by the monitoring circuitry 114. In some implementations of the circuit 100, the signal splitter and/or switch 104 is also coupled to the monitoring circuitry 114, such that the monitoring circuitry 114 can cause the signal splitter and/or switch 104 to switch the RF signal received by the antenna 102 between the RFID tag 106 and the RF-to-DC converter 108. Once the monitor 114 determines there is enough energy stored to complete an RFID transaction, the signal splitter and/or switch 104 can remove the connection between the antenna 102 and the RF-to-DC converter 108 and instead connect the antenna 102 to the RFID 106 to allow for RFID communications.

In operation of the circuit 100, the antenna 102 receives RF energy from an RFID reader and/or transmits data to the RFID reader (e.g., via backscatter), where the RF energy can be at a power level below the sensitivity threshold of the RFID 106. The signal splitter and/or switch 104 routes at least a portion of the RF energy to the RF-to-DC converter 108, which converts the RF energy to DC energy. The DC energy is stored in the energy storage device 112 over time. The monitoring circuitry 114 monitors the energy level in the energy storage device 112 and, when sufficient energy has been accumulated to complete an RFID transaction, enables the PMIC 116 to cause deliver power from the energy storage device 112 to the RFID 106. The RFID 106 remains powered for a period of time sufficient to complete the RFID transaction, after which the energy in the energy storage device 112 is depleted and the cycle repeats. The timing of the powering can be fixed or can be adjusted based on RF parameters, such as UHF electric product code (EPC) Generation 2 command lengths. In this manner, the RFID 106 is supplied intermittently with higher power rather than continuously with insufficient power, thereby extending the distance at which the RFID 106 can be powered by the RFID reader. In some implementations, the signal splitter and/or switch 104 initially routes RF energy to the RF-to-DC converter 108 while the RFID 106 is unpowered and presents a high impedance, and then switches to route RF energy to the RFID 106 once sufficient energy has been stored. In some implementations, if the RF-to-DC converter 108 is disconnected from the energy storage device 112, the DC output of the RF-to-DC converter 108 can go to an open circuit (raising the output voltage) or a short circuit, which changes the RF input impedance of the RF-to-DC converter 108 and causes more RF energy to be routed to the RFID 106. Once the stored energy has been depleted, the signal splitter and/or switch 104 switches back to route RF energy to the RF-to-DC converter 108. The components of the circuit 100, including the signal splitter and/or switch 104, the RF-to-DC converter 108, the energy storage device 112, the monitoring circuitry 114, and the PMIC 116, can be implemented for example as discrete components placed on the same substrate as the RFID 106, such as a printed circuit board or an RFID inlay, and/or integrated (e.g., within a common chip).

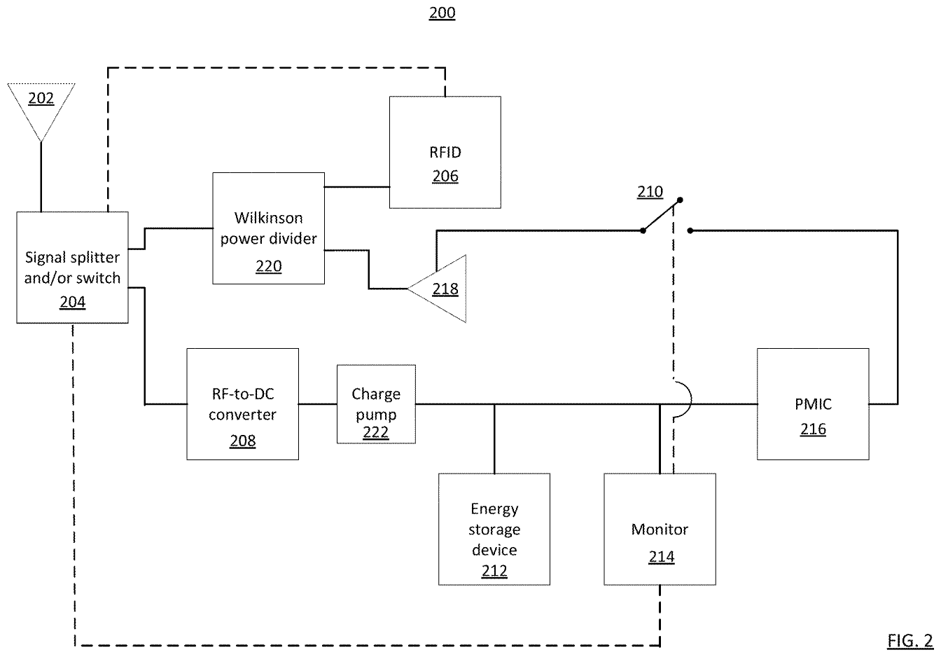

FIG. 2 illustrates a circuit 200, according to an embodiment. The antenna 202 can have the same or similar structure and/or functionality as the antenna 102 of FIG. 1. The signal splitter and/or switch 204 can have the same or similar structure and/or functionality as the signal splitter and/or switch 104 of FIG. 1. The RFID 206 can have the same or similar structure and/or functionality as the RFID 106 of FIG. 1. The RF-to-DC converter 208 can have the same or similar structure and/or functionality as the RF-to-DC converter 108 of FIG. 1. The switch 210 can have the same or similar structure and/or functionality as the switch 110 of FIG. 1. The energy storage device 212 can have the same or similar structure and/or functionality as the energy storage device 112 of FIG. 1. The monitoring circuitry 214 can have the same or similar structure and/or functionality as the monitoring circuitry 114 of FIG. 1. The PMIC 216 can have the same or similar structure and/or functionality as the PMIC 116 of FIG. 1.

The circuit 200 includes an antenna 202 coupled to a signal splitter and/or switch 204 via a wired connection. The signal splitter and/or switch 204 is coupled to a Wilkinson power divider 220 via a wired connection. The signal splitter and/or switch 204 is coupled to an RF-to-DC converter 208 via a wired connection. The signal splitter or switch 204 can be controlled by at least one of the RFID 206 or the monitor 214. The Wilkinson power divider 220 can be implemented using discrete components. The Wilkinson power divider 220 is coupled to an RFID 206 via a wired connection and is coupled to a reflection amplifier 218 via a wired connection. The RFID 206 and the reflection amplifier 218 are coupled in parallel to the Wilkinson power divider 220, such that the Wilkinson power divider 220 divides the RF energy between the RFID 206 and the reflection amplifier 218. The reflection amplifier 218 is an amplifier configured to amplify and reflect an incoming RF energy back toward the source (e.g., an RFID reader), thereby increasing the communication link budget, particularly in the reverse communication path (tag-to-reader), by amplifying the backscattered signal. The PMIC 216 is coupled to the reflection amplifier 218 via switch 210, such that the PMIC 216 can selectively deliver power to the reflection amplifier 218. The switch 210 can be controlled by the monitor 214.

In an operation of the circuit 200, the antenna 202 receives an RF signal, the energy of that RF signal being below the threshold of energy the RFID 206 uses to operate. The signal splitter and/or switch 204 initially directs substantially all of the energy in that RF signal to the RF-to-DC converter 208. The Wilkinson power divider 220 initially receives little to none of that RF signal. The RF-to-DC converter 208 is configured to convert the RF signal to DC energy. The DC energy can be stored in the energy storage device 212. The monitoring circuitry 214 monitors the energy level in the energy storage device 212 and, when sufficient energy has been accumulated to complete an RFID transaction, enables the PMIC 216, and causes power to be sent from the PMIC 216 to the reflection amplifier 218 by closing switch 210. Concurrently, the monitoring circuitry 214 is configured to direct the RF signal away from the RF-to-DC converter 208 and instead direct the RF signal to the Wilkinson power divider 220 by controlling the signal splitter and/or switch 204. The Wilkinson power divider 220 is configured to receive a portion of the RF signal, amplify that portion of the RF signal at the same frequency, and direct the amplified signal to the RFID tag 206. The RFID tag 206 is configured to decode and respond to this RF signal, directing the response back to the reflection amplifier 218 for amplification. The new amplified response is directed back to the antenna 202 through the Wilkinson power divider 220 and the signal splitter and/or switch 204 for backscatter radiation. The energy storage 212 at this time can be below the energy required to power the RFID tag 206 or below the operational voltage of the PMIC 216, such that the system 200 is re-charged.

The RF-to-DC converter 208 can further be coupled to an optional charge pump 222. The charge pump 222 is coupled to an energy storage device 212. The energy storage device 212 is coupled to monitoring circuitry (monitor 214) via a wired connection. The monitoring circuitry 214 is coupled to a PMIC 216 via a wired connection. The charge pump 222 is configured to increase the voltage of the DC energy output by the RF-to-DC converter 208 before the DC energy is stored in the energy storage device 212. The circuit 200 can increase the link budget on both the forward communication path (reader-to-tag) and the reverse communication path (tag-to-reader), as well as increasing the distance at which the RFID 206 can be powered. The components of the circuit 200 can be the same as or similar to the components of the circuit 100 of FIG. 1 (e.g., the signal splitter and/or switch 204 can include a coupler, a circulator, or an isolator, as described with respect to the signal splitter and/or switch 104). The components of the circuit 200 can be implemented as discrete components placed on the same substrate, be designed into an integrated circuit, or be discrete die integrated into the same package.

Monitor 214 can be coupled to the signal splitter and/or switch 204, thereby enabling the monitoring circuitry 214 to actively control the routing of RF energy between the RF-to-DC converter 208 and/or the reflection amplifier 218 based on the energy level in the energy storage device 212. The RFID 206 can be coupled and configured to send control signals to the signal splitter and/or switch 204, thereby enabling the RFID 206 to direct the RF signal back to the RF-to-DC converter 208 upon completion of the RFID transaction.

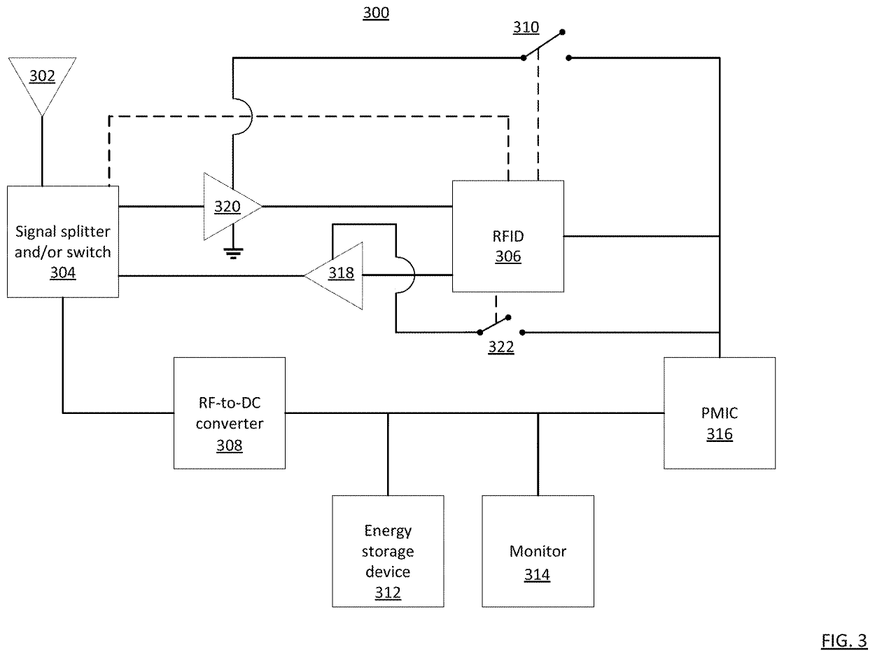

FIG. 3 illustrates a circuit 300, according to an embodiment. The antenna 302 can have the same or similar structure and/or functionality as the antenna 102 of FIG. 1. The signal splitter and/or switch 304 can have the same or similar structure and/or functionality as the signal splitter and/or switch 104 of FIG. 1. The RFID 306 can have the same or similar structure and/or functionality as the RFID 106 of FIG. 1. The RF-to-DC converter 308 can have the same or similar structure and/or functionality as the RF-to-DC converter 108 of FIG. 1. The energy storage device 312 can have the same or similar structure and/or functionality as the energy storage device 112 of FIG. 1. The monitoring circuitry 314 can have the same or similar structure and/or functionality as the monitoring circuitry 114 of FIG. 1. The PMIC 316 can have the same or similar structure and/or functionality as the PMIC 116 of FIG. 1.

The circuit 300 includes an antenna 302 coupled to a signal splitter and/or switch 304 via a wired connection. The signal splitter and/or switch 304 is coupled to a low noise amplifier (LNA) 320 via a wired connection, to a reflection amplifier 318 via a wired connection, and to an RF-to-DC converter 308 via a wired connection. The LNA 320 and the reflection amplifier 318 are coupled in parallel to the signal splitter and/or switch 304. The LNA 320 configured to amplify the RF signal from the antenna 302 and direct that amplified signal to RFID 306 for demodulation, thereby increasing the forward communication link budget (reader-to-tag). The LNA 320 is coupled to switch 310. Switch 310 is coupled to the RFID tag 306 and to the PMIC 316, and configured to deliver power to the LNA 320 based on a control signal from the RFID tag 306. The reflection amplifier 318 is configured to amplify the RF signal from the antenna 302 and direct the amplified signal back to the antenna 302 through the signal splitter and/or switch 304 for radiation by the antenna 302. The reflection amplifier 318 is coupled to switch 322. The switch 322 is coupled to the PMIC 316 for power and to the RFID tag 306 for control. The switch 322 is configured to deliver power from the PMIC 316 to the reflection amplifier 318 based on a control signal from the RFID tag 306. The RFID tag 306 is configured to modulate data on the control signal from the RFID tag 306 to the switch 322. In some implementations, the RFID tag 306 is configured to modulate data by controlling the DC power supply to the reflection amplifier 318 via the switch 322, such that selectively enabling and disabling the DC power supply to the reflection amplifier 318 causes the reflection amplifier 318 to alternately transmit and cease transmitting amplified RF energy, thereby achieving amplitude-shift keying (ASK) modulation of the backscattered signal. The combination of the LNA 320 and the reflection amplifier 318 increases the communication link budget in both the forward direction (reader-to-tag, via the LNA 320) and the reverse direction (tag-to-reader, via the reflection amplifier 318). The RF-to-DC converter 308 is coupled to an energy storage device 312 via a wired connection. The energy storage device 312 is coupled to monitoring circuitry (monitor 314) via a wired connection, and to the PMIC 316 via a wired connection. The signal splitter and/or switch 304 is coupled to the RFID 306 to allow RFID 306 to control the switching of RF power between the LNA 320, the reflection amplifier 318 and the RF-to-DC converter 308.

In an operation of circuit 300, an RF signal is received on antenna 302 from an RFID reader, the RF signal containing both RF energy and an RFID command. The signal splitter and/or switch 304 is configured to initially direct the majority if not all of the RF signal to the RF-to-DC converter 308. The RF-to-DC converter 308 is configured to convert the RF signal to DC energy. The DC energy is then stored in the energy storage device 312. The monitoring circuitry 314 monitors the energy level in the energy storage device 312 and, when sufficient energy has been accumulated to complete an RFID transaction, enables the PMIC 316. PMIC 316 is configured to apply power to the RFID tag 306. The RFID tag 306 is configured to now switch the RF signal from the RF-to-DC converter 308 to the LNA 320 via the signal splitter and/or switch 304, and to apply power to the LNA 320 from the PMIC 316 by closing switch 310. The LNA 310 is configured to amplify the command modulated on the RF signal to increase the forward link budget (reader to tag). The RFID tag 306 is configured to respond to this command by backscattering data. The RFID 306 now sends the RF signal to the reflection amplifier 318 for amplification by controlling the signal splitter and/or switch 304. The RFID 306 is also configured to apply power from the PMIC 316 to the reflection amplifier 318 by closing switch 322. The backscatter data can be modulated onto the control of switch 322. The reflection amplifier 318 is configured to amplify and modulate the backscatter data and direct the signal back to antenna 302 to be radiated. At this time the energy storage device 312 can run out of energy, causing the system 300 to start over. In some implementations, the RFID 306 modulates backscatter data by selectively enabling and disabling the DC power supply to the reflection amplifier 318 via switch 322: when DC power is supplied, the reflection amplifier 318 amplifies and transmits the RF signal, and when DC power is removed, the reflection amplifier 318 ceases transmitting, thereby achieving amplitude-shift keying (ASK) modulation of the backscattered signal. The reflection amplifier 318 is configured to direct the modulated and amplified signal back to antenna 302 to be radiated.

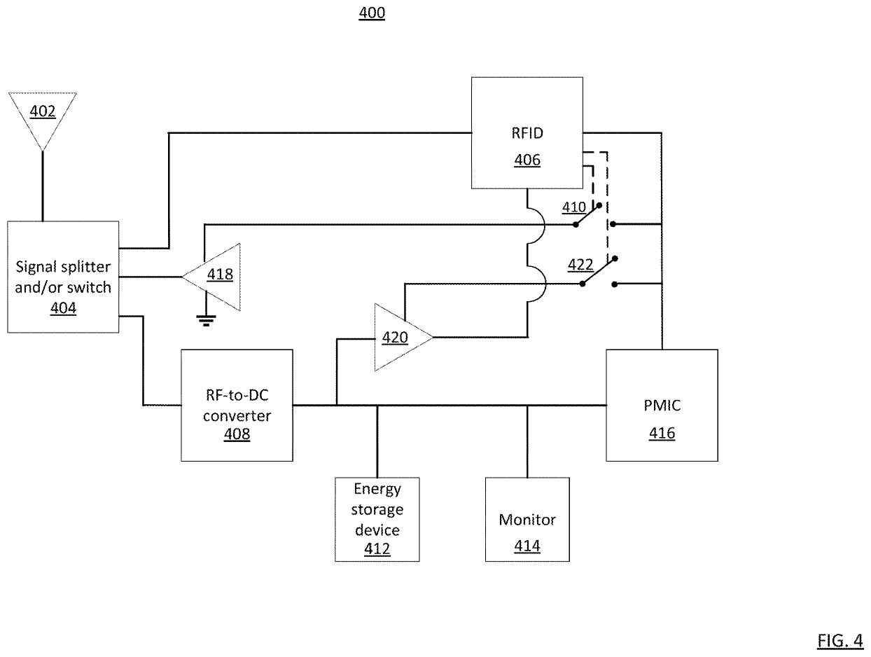

FIG. 4 illustrates a circuit 400, according to an embodiment. The antenna 402 can have the same or similar structure and/or functionality as the antenna 102 of FIG. 1. The signal splitter and/or switch 404 can have the same or similar structure and/or functionality as the signal splitter and/or switch 104 of FIG. 1. The RFID 406 can have the same or similar structure and/or functionality as the RFID 106 of FIG. 1. The RF-to-DC converter 408 can have the same or similar structure and/or functionality as the RF-to-DC converter 108 of FIG. 1. The energy storage device 412 can have the same or similar structure and/or functionality as the energy storage device 112 of FIG. 1. The monitoring circuitry 414 can have the same or similar structure and/or functionality as the monitoring circuitry 114 of FIG. 1. The PMIC 416 can have the same or similar structure and/or functionality as the PMIC 116 of FIG. 1.

The circuit 400 includes an antenna 402 coupled to a signal splitter and/or switch 404 via a wired connection. The signal splitter and/or switch 404 is coupled to a reflection amplifier 418 via a wired connection and to an RF-to-DC converter 408 via a wired connection. The signal splitter and/or switch 404 also coupled to the RFID 406 to allow the RFID 406 to control the flow of the RF signal between the reflection amplifier 418 and the RF-to-DC converter 408. The reflection amplifier 418 and the RF-to-DC converter 408 are coupled in parallel to the signal splitter and/or switch 404. The RF-to-DC converter 408 is coupled to an energy storage device 412 via a wired connection. The voltage on the energy storage device 412 is configured to increase due to the increase in stored energy. The monitoring circuitry 414 is coupled to the energy storage device 412 and configured to monitor the voltage of the energy storage device 412. The PMIC 416 is coupled to the energy storage device 412. When the monitoring circuitry 414 determines sufficient energy is stored to complete an RFID transaction, the monitoring circuitry 414 enables the PMIC 416. The RFID 406 is coupled to the PMIC 416 such that the PMIC 416 receives power when the PMIC 416 is enabled. The PMIC 416 is configured to increase the voltage of the energy storage device 414 to a voltage level usable by the RFID 406. The RF-to-DC converter 408 is also coupled to an operational amplifier 420 via a wired connection. The operational amplifier 420 is coupled to the RFID 406 via a wired connection. The operational amplifier 420 is coupled to switch 422. Switch 422 is coupled to the PMIC 416 and configured to deliver power to the operational amplifier 420 via a control signal from RFID 406. The RF-to-DC converter 408 is configured to act as a demodulator, sending the demodulated signal to the operational amplifier 420. The operational amplifier 420 is configured to amplify the demodulated signal from the RF-to-DC converter 408 before delivering it to the RFID 406. The RFID 406 is configured to respond to the amplified demodulated signal. The reflection amplifier 418 is coupled to switch 410. The switch 410 is coupled to the RFID 406 for control and to the PMIC 416 for power, and configured to send power from the PMIC 416 to the reflection amplifier 418 in response to the RFID 406. When switch 410 is closed, the PMIC 416 can deliver power to the reflection amplifier 418 to increase the reverse communication link budget (tag-to-reader). The data to be reflected back to the reader from RFID 406 is modulated onto the control signal of switch 410. When switch 422 is closed, the PMIC 416 can deliver power to the operational amplifier 420 to amplify the demodulated signal from the RF-to-DC converter 408. The energy storage device 412 is coupled to monitoring circuitry (monitor 414) via a wired connection. The monitoring circuitry 414 is coupled to the PMIC 416 via a wired connection.

In an operation of the circuit 400, the circuit 400 performs similar in function to the circuit 300. Where there circuit 300 relied on amplifying the incoming RF signal via the LNA 320 and the RFID 306 to demodulate the RF signal, the circuit 400 relies on the RF-to-DC converter 408 to demodulate the RF signal and an operational amplifier 420 to amplify the demodulated signal.

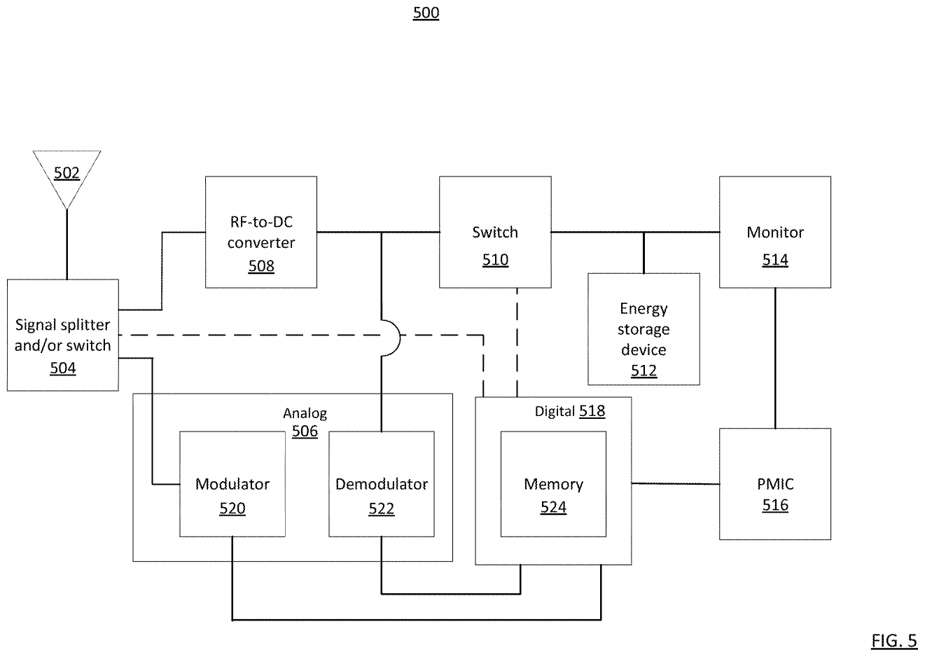

FIG. 5 illustrates a circuit 500, according to an embodiment. Unlike the circuits 100, 200, 300, and 400 of FIGS. 1-4, which use discrete components surrounding a separate RFID chip, the circuit 500 integrates RFID functionality into the circuit itself. In some implementations, some or all of the components of the circuit 500 are integrated into a single chip, such as an application-specific integrated circuit (ASIC). The circuit 500 includes an antenna 502 coupled to a signal splitter and/or switch 504 via a wired connection. The antenna 502 is configured to receive an RF signal from an RFID reader and containing a RF energy and an RFID command. The signal splitter and/or switch 504 can include an impedance matching network(s), can include circuits that introduce Q multiplication voltage, and can be implemented as a switch, coupler, circulator, power splitter, or power divider. In some implementations, the signal splitter and/or switch 504 is normally open or normally closed to the RF-to-DC converter 508 and/or the analog circuit 506. The signal splitter and/or switch 504 is coupled to an RF-to-DC converter 508 via a wired connection and to the analog circuitry 506 of system via a wired connection. The signal splitter and/or switch 504 is configured to be controlled by the coupled digital circuitry 518. The RF-to-DC converter 508 is coupled to a switch 510 via a wired connection and configured to convert the RF signal to DC energy and to demodulate the received RF signal. The switch 510 is coupled to an energy storage device 512 via a wired connection and to the RF-to-DC converter 508 via a wired connection. The switch 510 is configured store the DC energy in the energy storage device 512 via a control signal from the digital circuitry 518. The energy storage device 512 is coupled to monitoring circuitry (monitor 514) via a wired connection and the energy storage device 512 is configured to monitor the energy stored in the energy storage device 512 by monitoring its corresponding voltage. The monitoring circuitry 514 is coupled to the energy storage device 512 via a wired connection and is coupled to a PMIC 516 via a wired connection. The monitoring circuitry 514 is configured to enable to PMIC once enough energy is stored in the energy storage device 512. Although only one RF-to-DC converter 508 is shown in FIG. 5, the circuit alternatively can contain multiple RF-to-DC converters tuned for different properties, such as different RF input power levels.

The PMIC 516 is coupled to a digital circuit 518 via a wired connection and the PMIC 516 is configured to power the digital circuitry 518 in response to a signal from the monitoring circuitry 514. The digital circuit 518 includes a memory 524. The memory 524 is configured to store data associated with RFID operations, such as tag identification data, configuration data, or transaction data. The digital circuit 518 is coupled to the switch 510 and the signal splitter and/or switch 504 such that the digital circuit 518 can control the characteristics of the switch 504, such as open/closed or RF power split. The circuit 500 further includes an analog circuit 506 that includes a modulator 520 and a demodulator 522. The analog circuit 506 is configured to receive power from the PMIC 516 through the digital circuitry 518. The modulator 520 is configured to modulate data from the digital circuit 518 onto an RF carrier signal for transmission via the signal splitter and/or switch 504 and the antenna 502. The modulator 520 is coupled between the digital circuit 518 and the signal splitter and/or switch 504. The demodulator 522 is configured to demodulate incoming RF energy (e.g., RF signals) to extract data for processing by the digital circuit 518. The demodulator 522 is coupled between (1) the digital circuit 518 and (2) the RF-to-DC converter 508 and the switch 510. The RF-to-DC 508 converter can act as the demodulating circuit or work in conjunction with demodulator 522 to demodulate the RF signal. The switch 510 can be opened via a control signal from the digital circuitry 518 to allow the amplitude shift keying modulation on the output of the RF-to-DC converter 508 to be seen by the demodulator 522 with the energy storage device 512 holding the signal high. The PMIC 516 is configured to cause delivery of power from (or allow power to pass through) the energy storage device 512 to the digital circuit 518 upon the monitoring circuitry 514 determining that sufficient energy is stored at the energy storage device 512 to complete an RFID transaction. The PMIC 516 can also at this time increase the voltage level of the energy storage device 512 to a voltage level used to power at least one of the digital circuitry 518 or the analog circuitry 506. In some implementations, the switches in the circuit 500 are RF switches or field-effect transistors (FETs). The circuit 500 is similar in function to the circuit 100 of FIG. 1 in that it stores RF energy and intermittently powers the RFID functionality when sufficient energy has been accumulated, but the circuit 500 integrates the RFID functionality (e.g., the analog circuit 506, the digital circuit 518, and the memory 524) rather than using a separate RFID chip.

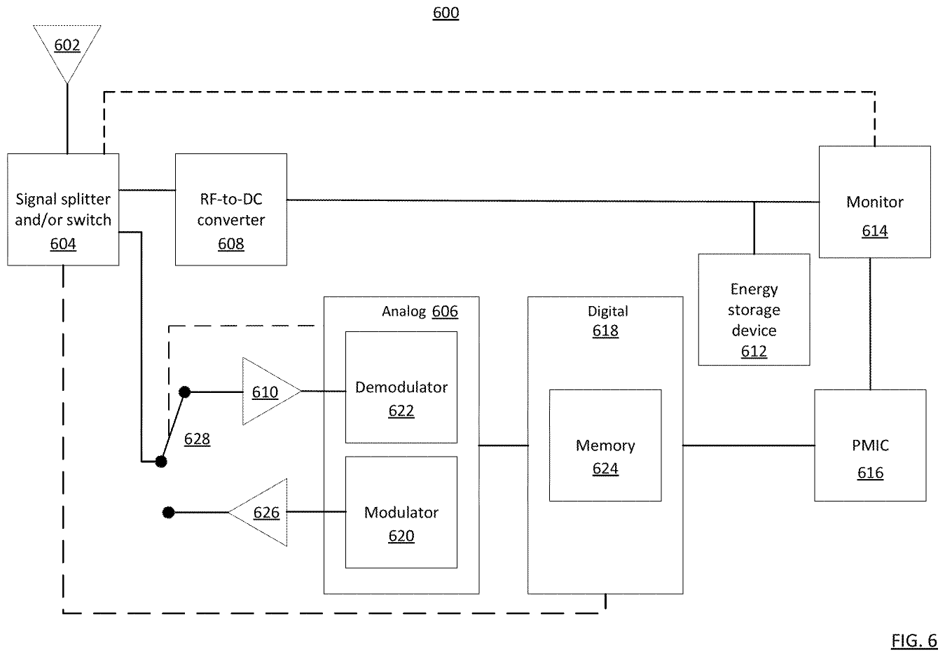

FIG. 6 illustrates a circuit 600, according to an embodiment. The antenna 602 can have the same or similar structure and/or functionality as the antenna 102 of FIG. 1. The signal splitter and/or switch 604 can have the same or similar structure and/or functionality as the signal splitter and/or switch 104 of FIG. 1. The RF-to-DC converter 608 can have the same or similar structure and/or functionality as the RF-to-DC converter 108 of FIG. 1. The energy storage device 612 can have the same or similar structure and/or functionality as the energy storage device 112 of FIG. 1. The monitoring circuitry 614 can have the same or similar structure and/or functionality as the monitoring circuitry 114 of FIG. 1. The PMIC 616 can have the same or similar structure and/or functionality as the PMIC 116 of FIG. 1. The analog circuit 606 can have the same or similar structure and/or functionality as the analog circuit 506 of FIG. 5. The digital circuit 618 can have the same or similar structure and/or functionality as the digital circuit 518 of FIG. 5. The modulator 620 can have the same or similar structure and/or functionality as the modulator 520 of FIG. 5. The demodulator 622 can have the same or similar structure and/or functionality as the demodulator 522 of FIG. 5. The memory 624 can have the same or similar structure and/or functionality as the memory 524 of FIG. 5.

Like the circuit 500 of FIG. 5, the circuit 600 integrates RFID functionality into the circuit itself, and in some implementations, some or all of the components of the circuit 600 are integrated into a single chip, such as an ASIC. The circuit 600 includes an antenna 602 coupled to a signal splitter and/or switch 604 via a wired connection. The signal splitter and/or switch 604 is coupled to an RF-to-DC converter 608 via a wired connection and to the switch 628 via a wired connection. The RF-to-DC converter 608 is coupled to an energy storage device 612 and the monitor 614 via a wired connection. The energy storage device 612 is coupled to monitoring circuitry (monitor 614) via a wired connection. The monitoring circuitry 614 is coupled to a PMIC 616 via a wired connection. The PMIC 616 is coupled to a digital circuit 618 via a wired connection. The digital circuit 618 includes a memory 624. The memory 624 is configured to store data associated with RFID operations, such as tag identification data, configuration data, or transaction data. The circuit 600 further includes an analog circuit 606 that includes a modulator 620 and a demodulator 622. The modulator 620 is couplable to the signal splitter and/or switch 604 via a first amplifier 626. The demodulator 622 is couplable to the signal splitter and/or switch 604 via a second amplifier 610. The circuit 600 further includes a switch 628 that can couple the signal splitter and/or switch 604 to the first amplifier 626 or the second amplifier 610. In some implementations, the first amplifier 626 is a reflection amplifier configured to modulate data back to the RFID reader. In some implementations, the reflection amplifier 626 modulates data by amplitude-shift keying (ASK) the DC power supply to the reflection amplifier, which has the advantage of backscattering data at the same frequency as the incoming RF energy (e.g., RF signal). The first amplifier 610 can be, for example, a LNA, operational amplifier, or an RF amplifier. The digital circuit 618 is coupled between the analog circuit 606 and the PMIC 616. The PMIC 616 is configured to cause delivery of power from (or allow power to pass through) the energy storage device 612 to the digital circuit 618 upon the monitoring circuitry 614 determining that sufficient energy is stored at the energy storage device 612. In some implementations, the PMIC 616 is a boost converter or charge pump configured to increase the voltage of the energy storage device. In some implementations, the monitoring circuitry 614 can switch the RF energy to communications when enough power is stored in the energy storage device 612. In some implementations, the digital circuit 618 can signal the monitoring circuitry 614 via the PMIC 616 to switch power back to the RF-to-DC converter 608 when UHF RFID functions are complete. The signal splitter and/or switch 604 can optionally be connected to the digital circuit 618 and/or the monitoring circuit 614, thereby enabling the digital circuit 618 to directly control the routing of RF energy (e.g., to switch between energy harvesting and communication modes) and/or enabling the monitoring circuitry 614 to actively control the signal splitter and/or switch 604 based on the energy level in the energy storage device 612.

In an operation of the circuit 600, the circuit 600 operates similarly to circuit 500 for the RF-to-DC converter (508, 608), monitoring circuitry (514, 614), and energy storage device (512, 612) such that they are configured to deliver power to the digital circuitry (518, 618). Circuit 600 increases the communication link budget for both the forward and reverse communication links. Circuit 600 introduces switch 628, reflection amplifier 626, and demodulation amplifier 610. After the powering of the digital circuitry 618 from the PMIC 616, the digital circuitry 618 switches the RF signal using signal splitter an/or RF switch 604 such that most if not all of the RF signal is now received by switch 628. The analog circuitry 606 or digital circuitry 618 configures the switch 628 to direct the RF signal first to the demodulation amplifier 610. The demodulation amplifier 610 is configured to amplify the RF signal and send the RF signal to the demodulator 622. The demodulator 622 is configured to demodulate the RF signal and send the RF command to the digital circuitry 618. The digital circuitry 618 is configured to respond the RF command by backscattering data, such as data contained in the memory 624. The digital circuitry is configured to send the data to the modulator 620 and to the switch 628 such that the reflection amplifier 626 is now coupled to the signal splitter and/or switch 604. The modulator 620 is configured to modulate the data onto the control and/or data lines going to the reflection amplifier 626. The reflection amplifier 626 is configured to amplify and modulate the data onto the RF signal to reflect the amplified, modulated RF signal back to the antenna 602 to be radiated.

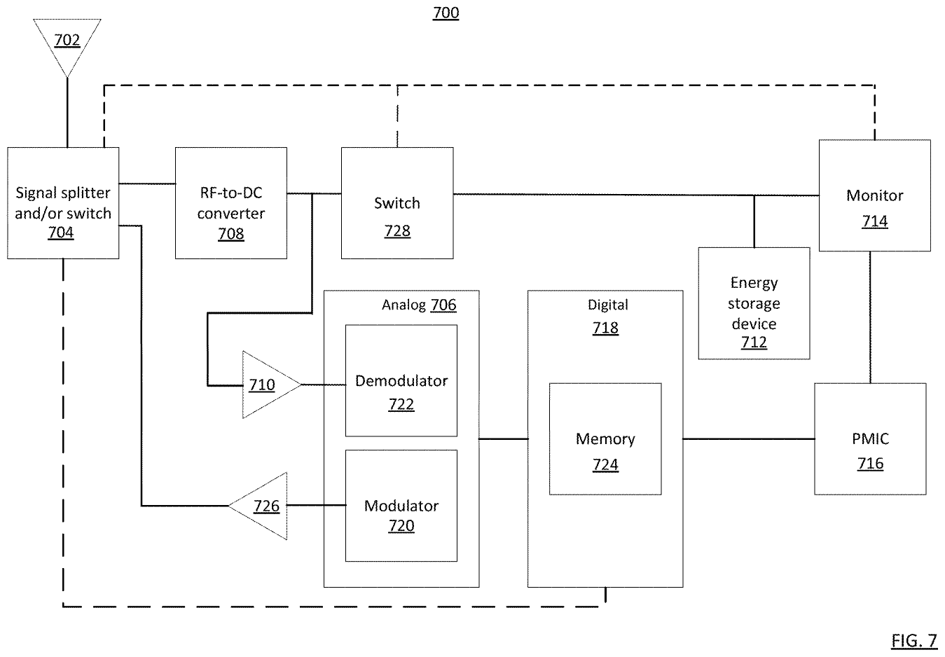

FIG. 7 illustrates a circuit 700, according to an embodiment. The antenna 702 can have the same or similar structure and/or functionality as the antenna 602 of FIG. 6. The signal splitter and/or switch 704 can have the same or similar structure and/or functionality as the signal splitter and/or switch 604 of FIG. 6. The analog circuit 706 can have the same or similar structure and/or functionality as the analog circuit 606 of FIG. 6. The RF-to-DC converter 708 can have the same or similar structure and/or functionality as the RF-to-DC converter 608 of FIG. 6. The amplifier 710 can have the same or similar structure and/or functionality as the amplifier 610 of FIG. 6. The energy storage device 712 can have the same or similar structure and/or functionality as the energy storage device 612 of FIG. 6. The monitoring circuitry 714 can have the same or similar structure and/or functionality as the monitoring circuitry 614 of FIG. 6. The PMIC 716 can have the same or similar structure and/or functionality as the PMIC 616 of FIG. 6. The digital circuit 718 can have the same or similar structure and/or functionality as the digital circuit 618 of FIG. 6. The modulator 720 can have the same or similar structure and/or functionality as the modulator 620 of FIG. 6. The demodulator 722 can have the same or similar structure and/or functionality as the demodulator 622 of FIG. 6. The memory 724 can have the same or similar structure and/or functionality as the memory 624 of FIG. 6. The amplifier 726 can have the same or similar structure and/or functionality as the amplifier 626 of FIG. 6.

The circuit 700 includes an antenna 702 coupled to a signal splitter and/or switch 704 via a wired connection. The signal splitter and/or switch 704 is coupled to an RF-to-DC converter 708 via a wired connection. Unlike the circuit 600 of FIG. 6, in which the RF-to-DC converter 608 is coupled directly to the energy storage device 612, the circuit 700 includes a switch 728 coupled between the RF-to-DC converter 708 and an energy storage device 712. The RF-to-DC converter 708 is coupled to the switch 728 via a wired connection. The switch 728 is coupled to the energy storage device 712 via a wired connection. The switch 728 allows the monitoring circuitry (monitor 714) to selectively connect or disconnect the RF-to-DC converter 708 from the energy storage device 712. The energy storage device 712 is coupled to the monitoring circuitry 714 via a wired connection. The monitoring circuitry 714 is coupled to the switch 728 via a wired connection and is coupled to a PMIC 716 via a wired connection. The PMIC 716 is coupled to a digital circuit 718 via a wired connection. The digital circuit 718 includes a memory 724. The circuit 700 further includes an analog circuit 706 that includes a modulator 720 and a demodulator 722. The modulator 720 is coupled to the signal splitter and/or switch 704 via a first amplifier 726 (e.g., reflection amplifier). The demodulator 722 is coupled to the RF-to-DC converter 708 via a second amplifier 710 (e.g., LNA, operational amplifier, or RF amplifier). The digital circuit 718 is coupled between the analog circuit 706 and the PMIC 716. The PMIC 716 is configured to cause delivery of power from the (or allow power to pass through) energy storage device 712 to the digital circuit 718 upon the monitoring circuitry 714 determining that sufficient energy is stored at the energy storage device 712. The signal splitter and/or switch 704 is optionally coupled to the digital circuit 718 and/or the monitoring circuit 714.

An operation of circuit 700 combines the operations of circuits 500 and 600, such that the demodulation amplifier (610, 710) and the reflection amplifier (626, 726) are added as in circuit 600, but the RF-to-DC (508, 608, 708) acts in conjunction with the demodulator (522, 622, 722).

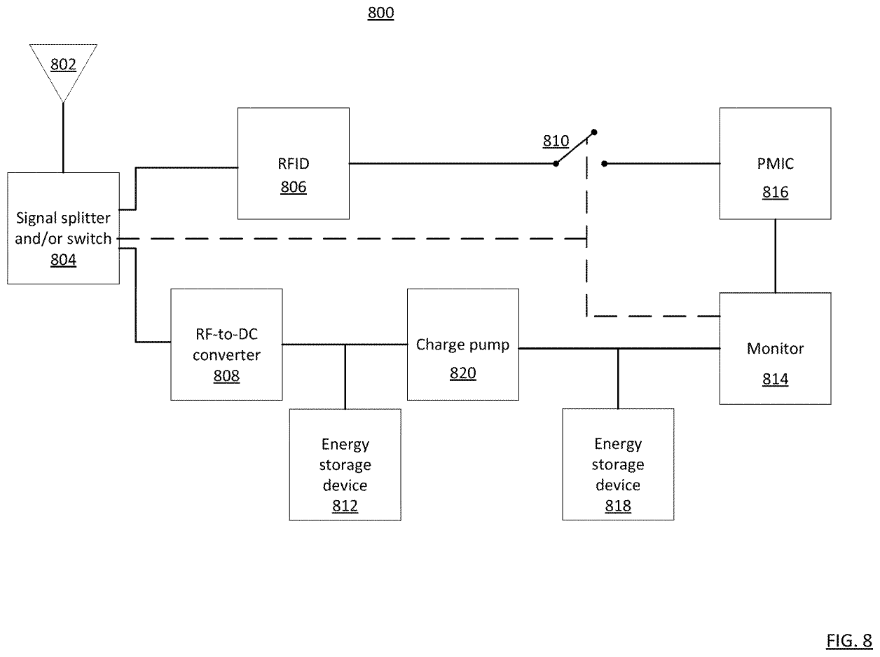

FIG. 8 illustrates a circuit 800, according to an embodiment. The antenna 802 can have the same or similar structure and/or functionality as the antenna 102 of FIG. 1. The signal splitter and/or switch 804 can have the same or similar structure and/or functionality as the signal splitter and/or switch 104 of FIG. 1. The RFID chip 806 can have the same or similar structure and/or functionality as the RFID chip 106 of FIG. 1. The RF-to-DC converter 808 can have the same or similar structure and/or functionality as the RF-to-DC converter 108 of FIG. 1. The monitoring circuitry 814 can have the same or similar structure and/or functionality as the monitoring circuitry 114 of FIG. 1. The PMIC 816 can have the same or similar structure and/or functionality as the PMIC 116 of FIG. 1.

The circuit 800 includes an antenna 802 coupled to a signal splitter and/or switch 804 via a wired connection. The signal splitter and/or switch 804 is coupled to an RFID 806 via a wired connection and is coupled to an RF-to-DC converter 808 via a wired connection. The PMIC 816 is couplable to the RFID 806 via a switch 810. The circuit 800 further includes a charge pump 820 coupled to the RF-to-DC converter 808 via a wired connection. The charge pump 820 is configured to increase the voltage of the DC energy output by the RF-to-DC converter 808 to usable logic levels. The charge pump 820 is coupled to a first energy storage device 818 via a wired connection. The energy storage device 818 is coupled to monitoring circuitry (monitor 814) via a wired connection. The monitoring circuitry 814 is coupled to the charge pump 820 via a wired connection and is coupled to a PMIC 816 via a wired connection. The PMIC 816 is configured to cause delivery of power from (or allow power to pass through) the energy storage device 818 to the RFID 806 upon the monitoring circuitry 814 determining that sufficient energy is stored at the energy storage device 818. The circuit 800 can optionally include a second energy storage device 812 coupled between the RF-to-DC converter 808 and the charge pump 820. The RF-to-DC converter 808 stores DC energy in the second energy storage device 812, and the charge pump 820 increases the voltage of the DC energy from the second energy storage device 812 before storing it in the energy storage device 818. The switch 810 can optionally connect the RFID 806 and the monitor 814.

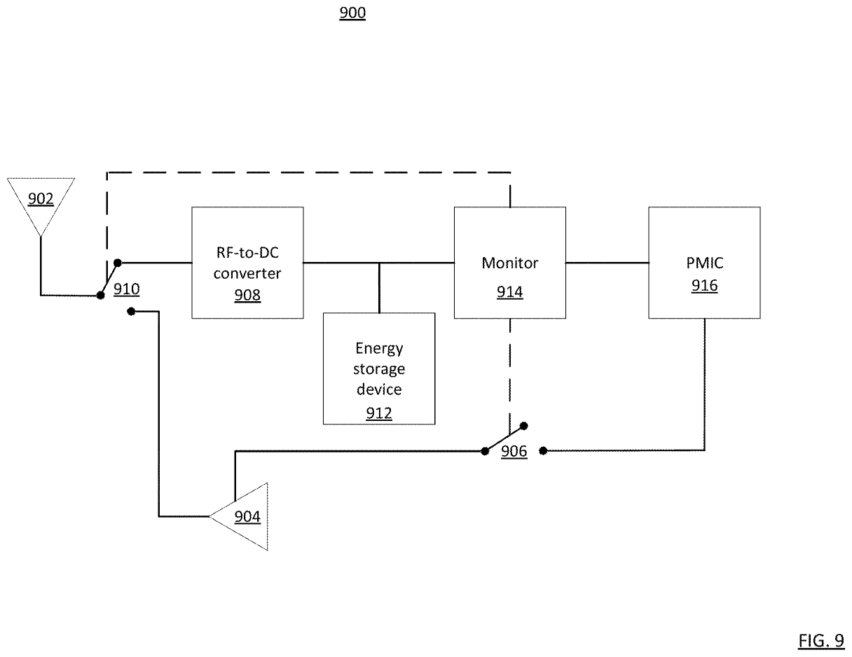

FIG. 9 illustrates a circuit 900, according to an embodiment. The antenna 902 can have the same or similar structure and/or functionality as the antenna 102 of FIG. 1. The RF-to-DC converter 908 can have the same or similar structure and/or functionality as the RF-to-DC converter 108 of FIG. 1. The energy storage device 912 can have the same or similar structure and/or functionality as the energy storage device 112 of FIG. 1. The monitoring circuitry 914 can have the same or similar structure and/or functionality as the monitoring circuitry 114 of FIG. 1. The PMIC 916 can have the same or similar structure and/or functionality as the PMIC 116 of FIG. 1. The reflection amplifier 904 can have the same or similar structure and/or functionality as the reflection amplifier 218 of FIG. 2.

The circuit 900 is configured to operate as an intermittently powered repeater or booster to increase the RFID power and communication link budget. The circuit 900 includes an antenna 902. The antenna 902 is coupled to a first switch 910. The first switch 910 is configured to selectively route RF energy from the antenna 902 to either an RF-to-DC converter 908 or a reflection amplifier 904. The RF-to-DC converter 908 is configured to be couplable to the antenna 902 via the first switch 910. The reflection amplifier 904 is configured to be couplable to the antenna 902 via the first switch 910. The RF-to-DC converter 908 is coupled to an energy storage device 912 via a wired connection. The energy storage device 912 is coupled to monitoring circuitry (monitor 914) via a wired connection. The monitoring circuitry 914 is coupled to the RF-to-DC converter 908 via a wired connection. The circuit 900 further includes a second switch 906. The monitoring circuitry 914 is coupled to the switch 906 such that the monitoring circuitry 914 can control the energy from the PMIC 916 to the reflection amplifier 904. The circuit 900 further includes a PMIC 916 coupled to the monitoring circuitry 914 via a wired connection. The PMIC 916 is couplable to the reflection amplifier 904 via the second switch 906. The circuit 900 is configured to, for example, increase the link budget by at least 3 dB.

In operation of the circuit 900, the first switch 910 initially routes RF energy from the antenna 902 to the RF-to-DC converter 908, which converts the RF energy to DC energy and stores it in the energy storage device 912. When the monitoring circuitry 914 determines that sufficient energy has been stored to power the reflection amplifier 904 for a predetermined amount of time, the first switch 910 switches to route RF energy from the antenna 902 to the reflection amplifier 904, and the second switch 906 connects the PMIC 916 (or the monitoring circuitry 914) to the reflection amplifier 904 to deliver power. The reflection amplifier 904 amplifies and reflects the RF energy back toward the RFID reader, thereby increasing the reverse communication link budget. A command from an external UHF RFID reader (also referred to herein as an “interrogator”) can also trigger the circuit 900 to enter a boost mode. The circuit 900 can amplify and reflect RF signals containing commands and responses from both RF readers and RFID tags. The reflection amplifier 904 can amplify and re radiate RF signals at the same frequency as the received RF signal.

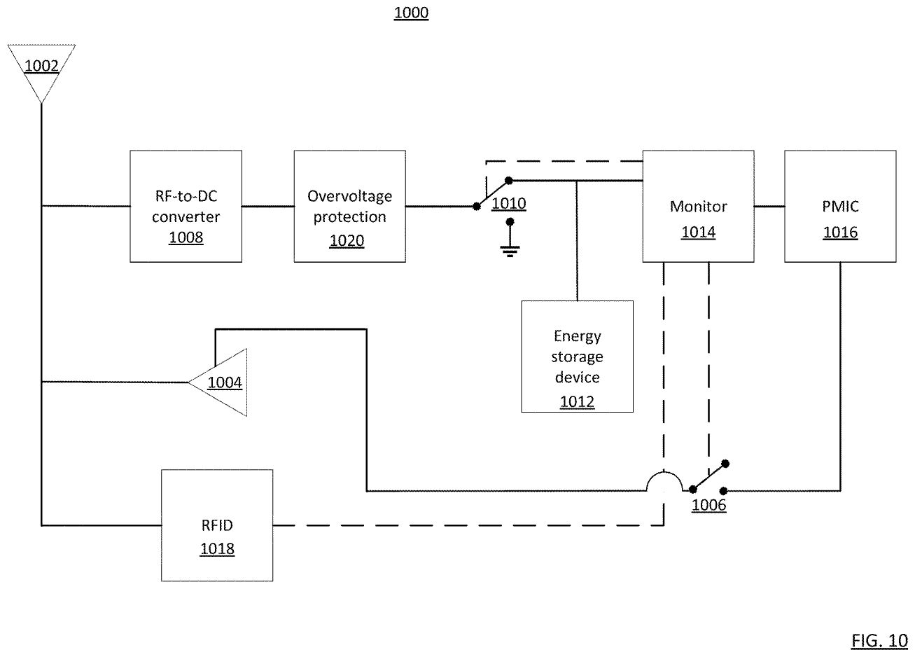

FIG. 10 illustrates a circuit 1000, according to an embodiment. The antenna 1002 can have the same or similar structure and/or functionality as the antenna 102 of FIG. 1. The RF-to-DC converter 1008 can have the same or similar structure and/or functionality as the RF-to-DC converter 108 of FIG. 1. The energy storage device 1012 can have the same or similar structure and/or functionality as the energy storage device 112 of FIG. 1. The monitoring circuitry 1014 can have the same or similar structure and/or functionality as the monitoring circuitry 114 of FIG. 1. The PMIC 1016 can have the same or similar structure and/or functionality as the PMIC 116 of FIG. 1. The reflection amplifier 1004 can have the same or similar structure and/or functionality as the reflection amplifier 904 of FIG. 9. The RFID 1018 can have the same or similar structure and/or functionality as the RFID 106 of FIG. 1.

The circuit 1000 includes an antenna 1002 coupled to an RF-to-DC converter 1008 via a wired connection. The antenna 1002 is also coupled to a reflection amplifier 1004 via a wired connection. The RF-to-DC converter 1008 is coupled to the RFID 1018. The RF-to-DC-converter 1008 is also coupled to the overvoltage protection circuitry 1020 via a wired connection. The overvoltage protection circuitry 1020 is configured to protect downstream components from excessive voltage levels output by the RF-to-DC converter 1008. The overvoltage protection circuitry 1020 is coupled to a first switch 1010 via a wired connection. The first switch 1010 is couplable to (1) an energy storage device 1012 or (2) ground or an open circuit. The energy storage device 1012 is coupled to monitoring circuitry (monitor 1014) via a wired connection. The monitoring circuitry 1014 is coupled to a PMIC 1016 via a wired connection. The reflection amplifier 1004 is coupled between the antenna 1002 and a second switch 1006. The second switch 1006 is switchable between a first configuration that connects the reflection amplifier 1004 to the monitoring circuitry 1014 and not the PMIC 1016, and a second configuration that connects the reflection amplifier 1004 to the PMIC 1016 and not the monitoring circuitry 1014.

The first switch 1010 is switchable between a first configuration that connects the overvoltage protection circuitry 1020 to the energy storage device 1012 and not ground, and a second configuration that connects the overvoltage protection circuitry 1020 to ground and not the energy storage device 1012. In some implementations, the first switch 1010 is configured to be switchable between being open and being connected to the energy storage device 1012. The circuit 1000 can optionally include an RFID 1018 coupled to the antenna 1002. The RFID 1018 can optionally be connected to the monitor 1014. In operation, the reflection amplifier 1004 can initially be unpowered, and some (e.g., most) of the RF energy received by the antenna 1002 is converted to DC by the RF-to-DC converter 1008 and stored in the energy storage device 1012 via the overvoltage protection circuitry 1020 and the first switch 1010. When the monitoring circuitry 1014 determines that sufficient energy has been stored to power the reflection amplifier 1004 for a predetermined amount of time, the energy storage device 1012 is disconnected from the RF-to-DC converter 1008 (e.g., by switching the first switch 1010). When the DC output of the RF-to-DC converter 1008 is disconnected from the energy storage device 1012, the DC output can go to an open circuit (higher impedance) or a short circuit (lower impedance), which changes the RF input impedance of the RF-to-DC converter 1008. The changed, now unmatched, RF input impedance causes most of the RF energy to be routed to the reflection amplifier 1004 instead of the RF-to-DC converter 1008. The second switch 1006 is switched to the second configuration to connect the PMIC 1016 to the reflection amplifier 1004, thereby delivering power from the energy storage device 1012 to the reflection amplifier 1004 via the PMIC 1016. A command from an external UHF RFID reader (e.g., the interrogator) can also trigger the circuit 1000 to enter a boost mode in which the reflection amplifier 1004 is powered by the energy storage device 1012 via the PMIC 1016 to amplify and reflect RF energy back toward the reader, thereby increasing the reverse communication link budget. In response to such a command, the output of the RF-to-DC converter 1008 can be driven to a high voltage (open) or ground (short) to cause the RF input impedance of the RF-to-DC converter 1008 to change, thereby redirecting RF energy to the reflection amplifier 1004.

Some implementations of the circuits described above with respect to FIGS. 1-10 (which can include a circuit that is a combination of a portion(s) of one circuit shown in and described for FIGS. 1-10 and a portion(s) of another circuit shown in and described in FIG. 110) increase the sensitivity and/or communication distance of the RFID tag when the amount of RF power immediately available to the tag is less than that required by the RFID tag, or when the amount of energy available to backscatter is not enough to effectively communicate with the RFID reader. The RFID tag's RF-to-DC converter, a shared RF-to-DC converter, or a separate RF-to-DC converter can convert the incoming RF energy (typically lower than that needed to power the tag) to DC energy. The DC energy is stored over time in an energy storage device, such as a capacitor. When the monitoring circuitry determines that enough energy is stored to power the tag, the monitoring circuitry enables the PMIC, which can then deliver (or allow passing through) the higher amount of power to the RFID tag. The RFID tag remains powered long enough to complete an RFID transaction, all the while draining the energy out of the energy storage device. Once the RFID tag loses power due to the PMIC turning off, the energy storage device charges back up and the cycle repeats. Thus, instead of the RFID tag being supplied continuously with little power, it is supplied intermittently with higher power.

In a first embodiment, a circuit (e.g., circuit 100, 200, 300, 400) includes an antenna (e.g., antenna 102, 202, 302, 402) configured to receive radio-frequency (RF) energy. The circuit further includes at least one of a signal splitter or a signal switch (e.g., signal splitter and/or switch 104, 204, 304, 404) coupled to the antenna and configured to route at least a portion of the RF energy. The circuit further includes an RF-to-DC converter (e.g., RF-to-DC converter 108, 208, 308, 408) coupled to the at least one of the signal splitter or the signal switch and configured to convert RF energy received from the at least one of the signal splitter or the signal switch into DC energy. The circuit further includes an energy storage device (e.g., energy storage device 112, 212, 312, 412) coupled to the RF-to-DC converter and configured to store the DC energy. The circuit further includes monitoring circuitry (e.g., monitor 114, 214, 314, 414) that is coupled to the energy storage device, coupled to the RF-to-DC converter, and configured to determine when an amount of energy stored in the energy storage device is sufficient to power a radio-frequency identification (RFID) (e.g., RFID 106, 206, 306, 406) to complete an RFID transaction. The circuit further includes a power management integrated circuit (PMIC) (e.g., PMIC 116, 216, 316, 416) coupled to the monitoring circuitry and configured to be couplable to the RFID, the PMIC configured to cause delivery of power from the energy storage device to the RFID upon the monitoring circuitry determining that sufficient energy is stored at the energy storage device.

Some implementations of the first embodiment further include a power divider (e.g., Wilkinson power divider 220) coupled between (1) the at least one of the signal splitter or the signal switch and (2) the RFID. The circuit further includes a reflection amplifier (e.g., amplifier 218) coupled between the power divider and the PMIC.

Some implementations of the first embodiment further include a Wilkinson power divider (e.g., Wilkinson power divider 220) coupled between (1) the at least one of the signal splitter or the signal switch and (2) the RFID. The circuit further includes a reflection amplifier (e.g., amplifier 218) couplable between the Wilkinson power divider and the PMIC.

Some implementations of the first embodiment further include a power divider (e.g., Wilkinson power divider 220) coupled between (1) the at least one of the signal splitter or the signal switch and (2) the RFID. The circuit further includes a reflection amplifier (e.g., amplifier 218) couplable between the power divider and the PMIC. The circuit further includes a charge pump (e.g., charge pump 222) coupled between the RF-to-DC converter and the energy storage device.

Some implementations of the first embodiment further include a switch (e.g., switch 110) coupled between the RFID and the PMIC.

In some implementations of the first embodiment, the at least one of the signal splitter or the signal switch is coupled to the monitoring circuitry, the energy storage device, and the PMIC.

Some implementations of the first embodiment further include a reflection amplifier (e.g., amplifier 318) coupled between (1) the at least one of the signal splitter or the signal switch and (2) the RFID. The circuit further includes a low noise amplifier (e.g., amplifier 320) coupled between (1) the at least one of the signal splitter or the signal switch and (2) the RFID.

Some implementations of the first embodiment further include a reflection amplifier (e.g., amplifier 318) coupled between (1) the at least one of the signal splitter or the signal switch, (2) the RFID, and (3) the PMIC via a first switch (e.g., switch 322). The circuit further includes a low noise amplifier (e.g., amplifier 320) coupled between (1) the at least one of the signal splitter or the signal switch, (2) the RFID, and (3) the PMIC via a second switch (e.g., switch 310).

Some implementations of the first embodiment further include a reflection amplifier (e.g., amplifier 418) coupled between (1) the at least one of the signal splitter or the signal switch and (2) the PMIC via a first switch (e.g., switch 410). The circuit further includes an operational amplifier (e.g., amplifier 420) coupled between the RF-to-DC converter, the RFID, and the PMIC via a second switch (e.g., switch 422).

In a second embodiment, a circuit (e.g., circuit 500) includes an antenna (e.g., antenna 502) configured to receive radio-frequency (RF) energy. The circuit further includes at least one of a signal splitter or a signal switch (e.g., signal splitter and/or switch 504) coupled to the antenna and configured to route at least a portion of the RF energy. The circuit further includes an RF-to-DC converter (e.g., RF-to-DC converter) coupled to the at least one of the signal splitter or the signal switch and configured to convert RF energy received from the at least one of the signal splitter or the signal switch into DC energy. The circuit further includes an energy storage device (e.g., energy storage device 512) coupled to the RF-to-DC converter via a switch (e.g., switch 510) and configured to store the DC energy. The circuit further includes monitoring circuitry (e.g., monitor 514) coupled to the energy storage device, coupled to the switch, and configured to determine when an amount of energy stored in the energy storage device is sufficient to complete an RFID transaction. The circuit further includes a digital circuit (e.g., digital 518) that includes a memory (e.g., memory 524) and that is coupled between the switch and the at least one of the signal splitter or the signal switch. The circuit further includes an analog circuit (e.g., analog 506) that includes a modulator (e.g., modulator 520) and a demodulator (e.g., demodulator 522). The modulator is coupled between the digital circuit and the at least one of the signal splitter or the signal switch. The demodulator is coupled between (1) the digital circuit and (2) the RF-to-DC converter and the switch. The circuit further includes a power management integrated circuit (PMIC) (e.g., PMIC 516) coupled to the monitoring circuitry and to the digital circuit. The PMIC is configured to cause delivery of power from the energy storage device to the digital circuit upon the monitoring circuitry determining that sufficient energy is stored at the energy storage device.

The circuit of 500 includes an antenna 502. The antenna 502 is configured to receive an RF signal from an RFID reader, the RF signal including an RF energy and a command from the RFID reader. The signal splitter and/or switch 504 is configured to initially direct most if not all of the received RF signal to the RF-to-DC converter 508. Analog circuitry 506 and digital circuitry 518 are initially unpowered. The RF-to-DC converter 508 is configured to convert the received RF signal to DC and store the DC energy in the energy storage device 512 through switch 510. The monitoring circuitry 514 is configured to monitor and determine when enough energy is stored in the energy storage device 512 to complete an RFID operation. Once enough energy has been stored, the monitor 514 wakes the PMIC 516, which boosts the voltage and delivers the energy in the energy storage device 512 to the digital circuitry 518. The digital circuitry 518 turns off switch 510 to direct the DC signal out of the RF-to-DC converter 508 to the demodulator 522, in order to not be held constantly high by energy storage device 512. The RF-to-DC 508 acts in conjunction with the demodulator 522 to demodulate the command on the RF signal. The demodulated RF command can be received at and interpreted by the digital circuitry 518. The digital circuitry 518 is configured to respond to the command by directing signal splitter and/or switch 504 to direct most if not all of the RF signal to the modulator 520 for backscatter communication. The digital circuitry 518 is configured to send data, such as data stored in memory 524, to the modulator 520. The modulator 520 is configured to modulate the data onto the received RF signal such that the RF signal is reflected back to antenna 502 to be radiated to the RFID reader.

In a third embodiment, a circuit (e.g., circuit 600) includes an antenna (e.g., antenna 602) configured to receive radio-frequency (RF) energy. The circuit further includes at least one of a signal splitter or a signal switch (e.g., signal splitter and/or switch 604) coupled to the antenna and configured to route at least a portion of the RF energy. The circuit further includes an RF-to-DC converter (e.g., RF-to-DC converter 608) coupled to the at least one of the signal splitter or the signal switch and configured to convert RF energy received from the at least one of the signal splitter or the signal switch into DC energy. The circuit further includes an energy storage device (e.g., energy storage device 612) coupled to the RF-to-DC converter and configured to store the DC energy. The circuit further includes monitoring circuitry (e.g., monitor 614) coupled to the energy storage device, coupled to the RF-to-DC converter, and configured to determine when an amount of energy stored in the energy storage device is sufficient to complete an RFID transaction. The circuit further includes an analog circuit (e.g., analog 606) that includes a modulator (e.g., modulator 620) and a demodulator (e.g., demodulator 622). The modulator is couplable to the at least one of the signal splitter or the signal switch via a first amplifier (e.g., amplifier 626). The demodulator is couplable to the at least one of the signal splitter or the signal switch via a second amplifier (e.g., amplifier 610). The circuit further includes a digital circuit (e.g., digital 618) that includes a memory (e.g., memory 624). The digital circuit is coupled between the analog circuit and a power management integrated circuit (PMIC) (e.g., PMIC 616). The circuit further includes the PMIC that is coupled between the monitoring circuitry and the digital circuit. The PMIC is configured to cause delivery of power from the energy storage device to the digital circuit upon the monitoring circuitry determining that sufficient energy is stored at the energy storage device.

The circuit of 600 includes an antenna 602. The antenna 602 is configured to receive an RF signal from an RFID reader, the RF signal including an RF energy and a command from the RFID reader. The signal splitter and/or switch 604 is configured to initially direct most if not all of the received RF signal to the RF-to-DC converter 608. Analog circuitry 606 and digital circuitry 618 are initially unpowered. The RF-to-DC converter 608 is configured to convert the received RF signal to DC energy and store the DC energy in the energy storage device. Monitoring circuitry 614 is configured to monitor and determine when enough energy is stored in the energy storage device 612 to complete an RFID operation. Once enough energy has been stored, the monitor 614 wakes the PMIC 616, which boosts the voltage and delivers the energy in the energy storage device 612 to the digital circuitry 618. The digital circuitry 618 is configured to, upon wakeup, direct the RF signal using signal splitter and/or switch 604 such that most if not all of the RF signal is now directed towards switch 628. Switch 628 is configured initially by the analog circuitry 606 or digital circuitry 618 to direct the RF signal to the demodulator 622. The demodulator 622 is configured to demodulate the signal and send the RF command to the digital circuitry 618. The digital circuitry 618 is configured to interpret the command and respond by backscattering data, such as data stored in the memory 624. The digital circuitry 618 is configured to send the data to the modulator 620 in the analog circuitry 606. The analog circuitry 606 is configured to switch via switch 628 the RF signal to the reflection amplifier 626. The modulator 620 is configured to send the data to the reflection amplifier by modulating the data onto the DC power to the reflection amplifier 620. The reflection amplifier is configured to modulate and amplify the data on the RF signal and direct the amplified and modulated RF signal to the antenna 602 via the switch 628 and the signal splitter and/or switch 604 to be radiated back to the RFID reader.

In a fourth embodiment, a circuit (e.g., circuit 700) includes an antenna (e.g., antenna 702) configured to receive radio-frequency (RF) energy. The circuit further includes at least one of a signal splitter or a signal switch (e.g., signal splitter and/or switch 704) coupled to the antenna and configured to route at least a portion of the RF energy. The circuit further includes an RF-to-DC converter (e.g., RF-to-DC converter 708) coupled to the at least one of the signal splitter or the signal switch and configured to convert RF energy received from the at least one of the signal splitter or the signal switch into DC energy. The circuit further includes an energy storage device (e.g., energy storage device 712) coupled to the RF-to-DC converter via a switch and configured to store the DC energy. The circuit further includes monitoring circuitry (e.g., monitor 714) coupled to the energy storage device, coupled to the switch, and configured to determine when an amount of energy stored in the energy storage device is sufficient to complete an RFID transaction. The circuit further includes an analog circuit (e.g., analog 706) that includes a modulator (e.g., modulator 720) and a demodulator (e.g., demodulator 722). The modulator is coupled to the at least one of the signal splitter or the signal switch via a first amplifier (e.g., amplifier 726). The demodulator is coupled to the RF-to-DC converter via a second amplifier (e.g., amplifier 710). The circuit further includes a digital circuit (e.g., digital 718) that includes a memory (e.g., memory 724). The digital circuit is coupled between the analog circuit and a power management integrated circuit (PMIC) (e.g., PMIC 716). The circuit further includes the PMIC coupled between the monitoring circuitry and the digital circuit. The PMIC is configured to cause delivery of power from the energy storage device to the digital circuit upon the monitoring circuitry determining that sufficient energy is stored at the energy storage device.

The circuit of 700 includes an antenna 702. The antenna 702 is configured to receive an RF signal from an RFID reader, the RF signal including an RF energy and a command from the RFID reader. The signal splitter and/or switch 704 is configured to initially direct most if not all of the received RF signal to the RF-to-DC converter 708. Analog circuitry 706 and digital circuitry 718 are initially unpowered. The RF-to-DC converter 708 is configured to convert the received RF signal to DC and store the DC energy in the energy storage device 712 through switch 728. Monitoring circuitry 714 is configured to monitor and determine when enough energy is stored in the energy storage device 712 to complete an RFID operation. Once enough energy has been stored, the monitor 714 wakes the PMIC 716, which boosts the voltage and delivers the energy in the energy storage device 712 to the digital circuitry 718. The digital circuitry 718 is configured to, upon wakeup, open switch 728 to direct the DC signal from the RF-to-DC converter 708 to the demodulation amplifier 710. The RF-to-DC converter 708 in this case is configured to act as a demodulator. The demodulated signal can be amplified by the demodulation amplifier 710. The amplified demodulated RF command can be interpreted by the digital circuitry 718. The digital circuitry 718 is configured to respond to the command by directing signal splitter and/or switch 704 to direct most if not all of the RF signal to the reflection amplifier 726 for backscatter communication. The digital circuitry 718 is configured to send data, such as data stored in memory 724, to the modulator 720. The modulator 720 is configured to modulate the data onto the DC supply to the reflection amplifier 726. The reflection amplifier 726 is configured to amplify the modulated signal on the RF signal. The RF signal is reflected back to antenna 702 to be radiated to the RFID reader.

In a fifth embodiment, a circuit (e.g., circuit 800) includes an antenna (e.g., antenna 802) configured to receive radio-frequency (RF) energy. The circuit further includes at least one of a signal splitter or a signal switch (e.g., signal splitter and/or switch 804) coupled to the antenna and configured to route at least a portion of the received RF energy. The circuit further includes an RFID (e.g., RFID 806) coupled to the at least one of the signal splitter or the signal switch and configured to receive first RF energy via the at least one of the signal splitter or the signal switch. The circuit further includes an RF-to-DC converter (e.g., RF-to-DC converter 808) coupled to the at least one of the signal splitter or the signal switch and configured to convert second RF energy received from the at least one of the signal splitter or the signal switch into DC energy. The circuit further includes a charge pump (e.g., charge pump 820) coupled to the RF-to-DC converter and configured to receive the DC energy. The circuit further includes an energy storage device (e.g., energy storage device 818) coupled to the charge pump. The charge pump is coupled between the energy storage device and the RF-to-DC converter. The circuit further includes monitoring circuitry (e.g., monitor 814) coupled to the energy storage device, coupled to the charge pump, and configured to determine when an amount of energy stored in the energy storage device is sufficient to power the RFID to complete an RFID transaction. The circuit further includes a power management integrated circuit (PMIC) (e.g., PMIC 816) coupled to the monitoring circuitry and couplable to the RFID. The PMIC is configured to cause delivery of power from the energy storage device to the RFID upon the monitoring circuitry determining that sufficient energy is stored at the energy storage device.

The circuit of 800 includes an antenna 802. The antenna 802 is configured to receive an RF signal from an RFID reader, the RF signal including an RF energy and a command from the RFID reader. The signal splitter and/or switch 804 is configured to initially direct most if not all of the received RF signal to the RF-to-DC converter 808. The RF-to-DC converter is configured to convert the RF signal to DC energy and store the DC energy in energy storage device 812. Charge pump 820 is coupled to energy storage device 812 and configured to increase the voltage of energy storage device 808. Energy storage device 818 coupled to the charge pump 820 and configured to store the higher voltage energy. Monitor 814 is configured to monitor the energy in storage device 818. Once enough energy is stored, the monitor 814 enables the PMIC 816. PMIC 816 directs the energy of energy storage device 818 to the RFID 806 through switch 810. The monitor 814 also controls the signal splitter and/or switch 804 such that now most if not all of the RF energy is directed to the RFID 806. RFID 806 can use the energy from the PMIC in battery assist mode to increase sensitivity.

In some implementations of the fifth embodiment, the energy storage device is a first energy storage device and the circuit further includes a second energy storage device (e.g., energy storage device 812) coupled to the RF-to-DC converter and the charge pump.

In a sixth embodiment, a circuit (e.g., circuit 900) includes an antenna (e.g., antenna 902). The circuit further includes a first switch (e.g., switch 910) coupled to the antenna. The circuit further includes an RF-to-DC converter (e.g., RF-to-DC converter) configured to be couplable to the antenna via the first switch. The circuit further includes an amplifier (e.g., amplifier 904) configured to be couplable to the antenna via the first switch. The circuit further includes an energy storage (e.g., energy storage device 912) coupled to the RF-to-DC converter. The circuit further includes a second switch (e.g., switch 906). The circuit further includes monitoring circuitry (e.g., monitor 914) that is coupled to the energy storage, coupled to the RF-to-DC converter, and couplable to the amplifier via the second switch.

In some implementations of the sixth embodiment, the switch is a first switch and the circuit further includes a power management integrated circuit (PMIC) (e.g., PMIC 916) coupled to the monitoring circuitry and couplable to the amplifier via the second switch.

In some implementations of the sixth embodiment, the first switch 910 is configured to direct most if not all of the RF signal to the RF-to-DC converter 908. RF-to-DC converter 912 is configured to convert the RF to DC energy and increase the DC energy in energy storage device 912. Monitor 914 is coupled to the energy storage device 912 and configured to monitor the energy stored. Once it is determined enough energy is stored, the monitor 914 enables the PMIC 916. The monitor 914 also directs the output of the PMIC 916 to power the reflection amplifier 904 through switch 906. The monitor also directs most if not all of the RF signal to the reflection amplifier.

In a seventh embodiment, a circuit (e.g., circuit 1000) includes an antenna (e.g., antenna 1002). The circuit further includes an RF-to-DC converter (e.g., RF-to-DC converter 1008) coupled to the antenna. The circuit further includes a first switch (e.g., switch 1010). The circuit further includes a second switch (e.g., switch 1006). The circuit further includes overvoltage protection circuitry (e.g., overvoltage protection 1020) coupled to the RF-to-DC converter and the first switch. The circuit further includes energy storage (e.g., energy storage device 1012) coupled to the overvoltage protection circuitry via the first switch. The circuit further includes monitoring circuitry (e.g., monitor 1014) coupled to the energy storage. The circuit further includes a power management integrated circuit (PMIC) (e.g., PMIC 1016) coupled to the monitoring circuitry. The circuit further includes an amplifier (e.g., amplifier 1004) coupled between the antenna and the second switch that is switchable between a first configuration that connects to the monitoring circuitry and not the PMIC, and a second configuration that connects to the PMIC and not the monitoring circuitry.

In some implementations of the seventh embodiment, the first switch is switchable between a first configuration that connects to the energy storage and not ground, and a second configuration that connects to ground and not the energy storage.

In some implementations of the seventh embodiment, the first switch is configured to be switchable between being open and being connected to the energy storage.

Some implementations of the seventh embodiment further include an RFID (e.g., RFID 1018) coupled between the antenna and the second switch.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

What is claimed is:

1. An apparatus, comprising:
an antenna configured to receive radio-frequency (RF) energy;
at least one of a signal splitter or a signal switch coupled to the antenna and configured to route at least a portion of the RF energy;
an RF-to-DC converter coupled to the at least one of the signal splitter or the signal switch and configured to convert RF energy received from the at least one of the signal splitter or the signal switch into DC energy;
an energy storage device coupled to the RF-to-DC converter and configured to store the DC energy;
monitoring circuitry that is coupled to the energy storage device, coupled to the RF-to-DC converter, and configured to determine when an amount of energy stored in the energy storage device is sufficient to power a radio-frequency identification (RFID) to complete an RFID transaction; and
a power management integrated circuit (PMIC) coupled to the monitoring circuitry and configured to be couplable to the RFID, the PMIC configured to cause delivery of power from the energy storage device to the RFID upon the monitoring circuitry determining that sufficient energy is stored at the energy storage device.

2. The apparatus of claim 1, further comprising:
a power divider configured to be couplable between (1) the at least one of the signal splitter or the signal switch and (2) the RFID; and
a reflection amplifier coupled between the power divider and the PMIC.

3. The apparatus of claim 1, further comprising:
a Wilkinson power divider configured to be couplable between (1) the at least one of the signal splitter or the signal switch and (2) the RFID; and
a reflection amplifier couplable between the Wilkinson power divider and the PMIC.

4. The apparatus of claim 1, further comprising:
a power divider configured to be couplable between (1) the at least one of the signal splitter or the signal switch and (2) the RFID;
a reflection amplifier couplable between the power divider and the PMIC; and
a charge pump coupled between the RF-to-DC converter and the energy storage device.

5. The apparatus of claim 1, further comprising:
a switch configured to be couplable between the RFID and the PMIC.

6. The apparatus of claim 1, wherein the at least one of the signal splitter or the signal switch is coupled to the monitoring circuitry, the energy storage device, and the PMIC.

7. The apparatus of claim 1, further comprising:
a reflection amplifier configured to be couplable between (1) the at least one of the signal splitter or the signal switch and (2) the RFID; and
a low noise amplifier configured to be couplable between (1) the at least one of the signal splitter or the signal switch and (2) the RFID.

8. The apparatus of claim 1, further comprising:
a reflection amplifier configured to be couplable between (1) the at least one of the signal splitter or the signal switch, (2) the RFID, and (3) the PMIC via a first switch; and
a low noise amplifier configured to be couplable between (1) the at least one of the signal splitter or the signal switch, (2) the RFID, and (3) the PMIC via a second switch.

9. The apparatus of claim 1, further comprising:
a reflection amplifier coupled between (1) the at least one of the signal splitter or the signal switch and (2) the PMIC via a first switch; and
an operational amplifier configured to be couplable between the RF-to-DC converter, the RFID, and the PMIC via a second switch.

10. The apparatus of claim 1, further comprising:
a charge pump coupled between the RF-to-DC converter and the monitoring circuitry.

11. The apparatus of claim 1, wherein the energy storage device is a first energy storage device, further comprising:
a charge pump coupled between the RF-to-DC converter and the monitoring circuitry; and
a second energy storage device coupled between the charge pump and the monitoring circuitry.

12. An apparatus, comprising:
an antenna configured to receive radio-frequency (RF) energy;
at least one of a signal splitter or a signal switch coupled to the antenna and configured to route at least a portion of the RF energy;
an RF-to-DC converter coupled to the at least one of the signal splitter or the signal switch and configured to convert RF energy received from the at least one of the signal splitter or the signal switch into DC energy;
an energy storage device coupled to the RF-to-DC converter via a switch and configured to store the DC energy;
monitoring circuitry coupled to the energy storage device, coupled to the switch, and configured to determine when an amount of energy stored in the energy storage device is sufficient to complete an RFID transaction;
an analog circuit that includes a modulator and a demodulator, the modulator coupled between a digital circuit and the at least one of the signal splitter or the signal switch, the demodulator coupled between (1) the digital circuit and (2) the RF-to-DC converter and the switch; and
a power management integrated circuit (PMIC) coupled to the monitoring circuitry and to the digital circuit, the PMIC configured to cause delivery of power from the energy storage device to the digital circuit upon the monitoring circuitry determining that sufficient energy is stored at the energy storage device.

13. The apparatus of claim 12, wherein the digital circuit includes a memory and the digital circuit is coupled between the switch and the at least one of the signal splitter or the signal switch.

14. An apparatus, comprising:
an antenna configured to receive radio-frequency (RF) energy;
at least one of a signal splitter or a signal switch coupled to the antenna and configured to route at least a portion of the RF energy;
an RF-to-DC converter coupled to the at least one of the signal splitter or the signal switch and configured to convert RF energy received from the at least one of the signal splitter or the signal switch into DC energy;
an energy storage device coupled to the RF-to-DC converter and configured to store the DC energy;
monitoring circuitry coupled to the energy storage device, coupled to the RF-to-DC converter, and configured to determine when an amount of energy stored in the energy storage device is sufficient to complete an RFID transaction;
an analog circuit that includes a modulator and a demodulator, the modulator couplable to the at least one of the signal splitter or the signal switch via a first amplifier, the demodulator couplable to the at least one of the signal splitter or the signal switch via a second amplifier;
a digital circuit that includes a memory, the digital circuit is coupled between the analog circuit and a power management integrated circuit (PMIC); and
the PMIC that is coupled between the monitoring circuitry and the digital circuit, the PMIC configured to cause delivery of power from the energy storage device to the digital circuit upon the monitoring circuitry determining that sufficient energy is stored at the energy storage device.

15. The apparatus of claim 14, wherein the monitoring circuitry is coupled to the at least one of the signal splitter or the signal switch.

16. The apparatus of claim 14, wherein the digital circuit is coupled to the at least one of the signal splitter or the signal switch.

17. The apparatus of claim 14, wherein the first amplifier is a reflection amplifier.

18. An apparatus, comprising:
an antenna configured to receive radio-frequency (RF) energy;
at least one of a signal splitter or a signal switch coupled to the antenna and configured to route at least a portion of the RF energy;
an RF-to-DC converter coupled to the at least one of the signal splitter or the signal switch and configured to convert the RF energy received from the at least one of the signal splitter or the signal switch into DC energy;
an energy storage device coupled to the RF-to-DC converter via a switch and configured to store the DC energy;
monitoring circuitry coupled to the energy storage device, coupled to the switch, and configured to determine when an amount of energy stored in the energy storage device is sufficient to complete an RFID transaction;
an analog circuit that includes a modulator and a demodulator, the modulator coupled to the at least one of the signal splitter or the signal switch via a first amplifier, the demodulator coupled to the RF-to-DC converter via a second amplifier;
a digital circuit that includes a memory, the digital circuit coupled between the analog circuit and a power management integrated circuit (PMIC); and
the PMIC coupled between the monitoring circuitry and the digital circuit, the PMIC configured to cause delivery of power from the energy storage device to the digital circuit upon the monitoring circuitry determining that sufficient energy is stored at the energy storage device.

19. The apparatus of claim 18, wherein the first amplifier is a reflection amplifier and the second amplifier is at least one of a low noise amplifier (LNA), an operational amplifier, or an RF amplifier.

20. The apparatus of claim 18, wherein the at least one of the signal splitter or the signal switch includes a plurality of passive tuning components configured to control splitting of the RF energy.
